(19) United States
(12) Patent Application Publication
(10) Pub. No.: US 2022/0360100 A1
(43) Pub. Date: Nov. 10, 2022

(54) STORAGE BATTERY DEVICE AND ELECTRIC VEHICLE

(71) Applicant: KABUSHIKI KAISHA TOSHIBA, Tokyo (JP)

(72) Inventors: Koji TAKAZAWA, Tokyo (JP); Kazuto KURODA, Tokyo (JP); Akio NISHIMAKI, Tokyo (JP); Yoshiyuki ISOZAKI, Tokyo (JP); Kaoru KOIWA, Tokyo (JP); Makoto MATSUOKA, Hachioji (JP); Hiroshi KUSAJIMA, Tokyo (JP); Motoshige IKEDA, Kashiwazaki (JP); Takuya IWASAKI, Uenohara (JP)

(73) Assignee: KABUSHIKI KAISHA TOSHIBA, Tokyo (JP)

(21) Appl. No.: 17/814,084

(22) Filed: Jul. 21, 2022

Related U.S. Application Data
(63) Continuation of application No. PCT/JP2020/017026, filed on Apr. 20, 2020.

(51) Int. Cl. H02J 7/00; H02J 7/34; H01M 50/204; H01M 50/249; H01M 10/42; H01M 10/44; H01M 50/574; H01M 10/48; H01M 50/296; B60L 53/20; B60L 58/12; B60L 58/18; B60L 3/00

(52) U.S. Cl. CPC H02J 7/00712; H02J 7/0063; H02J 7/0013; H02J 7/342; H02J 7/0049; H02J 7/00306; H02J 7/0031; H01M 50/204; H01M 50/249; H01M 10/425; H01M 10/441; H01M 50/574; H01M 10/482; H01M 50/296; B60L 53/20; B60L 58/12; B60L 58/18; B60L 3/0046; H02J 2207/20; H01M 2220/20; H01M 2010/4271; H01M 2200/00; B60L 2210/10

(57) ABSTRACT

A device according to one embodiment includes a first battery to output alternating-current power for driving a motor and connected to a first main circuit that is connected to an inverter; a second battery connected to a second main circuit, having a storage capacity larger than it of the first battery, and having a permissible power output per unit storage capacity smaller than it of the first battery; a DC/DC converter to convert a voltage of the second main circuit to a predetermined voltage and output to the first main circuit; a control circuit to control charging and discharging operations of the first and the second battery and an operation of the DC/DC converter; a first terminal connected to a positive terminal of the first battery; and a second terminal connected to a negative terminal of the first battery.

### CROSS-REFERENCE TO RELATED APPLICATIONS

This application is a Continuation Application of PCT Application No. PCT/JP2020/017026, filed Apr. 20, 2020, the entire contents of which are incorporated herein by reference.

### FIELD

Embodiments described herein relate generally to a storage battery device and an electric vehicle.

### BACKGROUND

A storage battery device incorporating a battery such as a lithium-ion battery is installed in various types of electronic apparatuses and moving vehicles. In general, a lithium-ion battery tends to deteriorate in accordance with an increase in temperature, and when the temperature further increases, the battery may possibly explode or ignite. For this reason, a storage battery device having a lithium-ion battery as a battery is designed to regularly detect and monitor the voltage and temperature of the battery so that, when the temperature exceeds its upper limit, the device can limit (or suspend) the charging and discharging of the battery.

For instance, when an electric vehicle having a lithium-ion battery as a driving power source is continuously driven, the temperature of the lithium-ion battery will increase. When the driver wants to charge the lithium-ion battery when the temperature of the battery has been increased the charging current for the lithium-ion battery may be regulated, prolonging the time required to charge the battery to bring the vehicle to a sufficiently drivable level.

### BRIEF DESCRIPTION OF THE DRAWINGS

FIG. 1 is a schematic diagram showing an exemplary configuration of a storage battery device according to the first embodiment.

FIG. 2A is a schematic diagram showing an exemplary configuration included in a battery management circuit of the storage battery device illustrated in FIG. 1.

FIG. 2B is a schematic diagram showing another exemplary configuration included in a battery management circuit of the storage battery device illustrated in FIG. 1.

FIG. 3 is a schematic diagram showing an exemplary usage state of the storage battery device according to an embodiment in an electric vehicle having the storage battery device installed therein.

FIG. 4 is a schematic diagram showing an exemplary configuration of the storage battery device according to the second embodiment.

FIG. 5 is a schematic diagram showing an exemplary configuration of the storage battery device according to the third embodiment.

FIG. 6 is a schematic diagram showing an exemplary configuration of the storage battery device and electric vehicle according to the fourth embodiment.

### DETAILED DESCRIPTION

In general, a storage battery device according to embodiments includes a first battery configured to output alternating-current power for driving a motor of a vehicle and connected to a first main circuit that is electrically connected to a direct-current terminal of an inverter to which regenerative power is supplied from the motor; a second battery connected to a second main circuit, having a storage capacity larger than a storage capacity of the first battery, and having a permissible power output per unit storage capacity smaller than a permissible power output of the first battery; a DC/DC converter configured to convert a voltage of power supplied from the second main circuit to a predetermined voltage and output the power to the first main circuit; a control circuit configured to control charging and discharging operations of the first battery and the second battery and control an operation of the DC/DC converter; a first terminal electrically connected to a positive terminal of the first battery via a high-potential side of the first main circuit; and a second terminal electrically connected to a negative terminal of the first battery via a low-potential side of the first main circuit.

Storage battery devices and electric vehicles according to several embodiments will be described in detail below with reference to the drawings. In these embodiments, the same reference numerals will be given to the same structural components, and the explanation of the overlapping elements will be omitted.

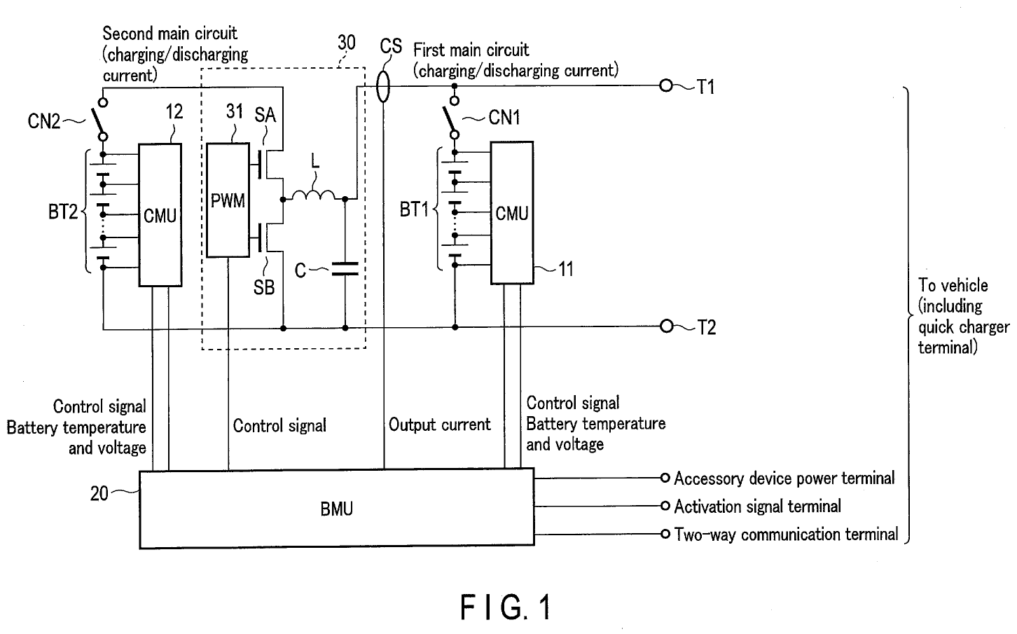

FIG. 1 is a schematic diagram showing an exemplary configuration of a storage battery device according to the first embodiment.

The storage battery device according to the present embodiment may be installed in a load apparatus such as an electric vehicle. The device discharges direct-current power to the load apparatus, and is charged with the direct-current power regenerated by the load apparatus.

The storage battery device according to the present embodiment includes a first battery module, a second battery module, a battery management circuit (battery management unit or BMU) 20, a DC/DC converter 30, a first terminal T1 , a second terminal T2, a current sensor CS, and breakers CN1 and CN2. The first battery module includes a first battery BT1 and a first battery monitoring circuit (cell monitoring unit or CMU) 11. The second battery module includes a second battery BT2 and a second battery monitoring circuit (cell monitoring unit or CMU) 12.

The first terminal T1 and second terminal T2 are charging/discharging terminals, which can be connected to the main circuit of a load apparatus with the storage battery device and to the charging terminal electrically connected to the main circuit.

The first battery BT1 is an assembled battery, in which battery cells are connected in series and/or in parallel. The positive terminal of the first battery BT1 is electrically connected to the first terminal Tl by way of the breaker CN1. The negative terminal of the first battery BT1 is electrically connected to the second terminal T2. The first battery BT1 output alternating-current power for driving the motor of the vehicle. The first battery BT1 is connected to the first main circuit that is electrically connected to the direct-current terminal of the inverter to which regenerative power is supplied from the motor.

The first battery monitoring circuit 11 may include, for example, at least one processor and a memory storing programs therein to be implemented by the processor, and may be configured to implement various functions by software (or by software and hardware in combination) . The first battery monitoring circuit 11 regularly acquires a temperature at least at one position in the vicinity of the first battery BT1 and voltages of the battery cells (voltage of the positive terminal and voltage of the negative terminal), and outputs them to the battery management circuit 20.

The second battery BT2 is an assembled battery, in which battery cells are connected in series and/or in parallel. The positive terminal of the second battery BT2 is connected to the positive terminal of the first battery BT1 by way of the breaker CN2 and DC/DC converter 30. The negative terminal of the second battery BT2 is electrically connected to the negative terminal of the first battery BT1 and the second terminal T2.

The second battery monitoring circuit 12 may include, for example, at least one processor and a memory that stores programs therein to be implemented by the processor, and may be configured to implement various functions by software (or by software and hardware in combination). The second battery monitoring circuit 12 regularly acquires a temperature at least at one position in the vicinity of the second battery BT2 and voltages of the battery cells (voltage of the positive terminal and voltage of the negative terminal) and outputs them to the battery management circuit 20.

In the storage battery device according to the present embodiment, the second battery BT2 has a larger storage capacity than that of the first battery BT1. Furthermore, at the time of being fully charged, the voltage of the second battery BT2 is higher than the voltage of the first battery BT1. By setting the voltage of the second battery BT2 higher than that of the first battery BT1, the current flowing through the DC/DC converter 30 can be maintained low. This allows a coil L included in the DC/DC converter 30, which will be described later, to be downsized. Thus, a reduced-size DC/DC converter 30 can be realized, and the storage battery device can be produced at reduced cost.

The first battery BT1 is more suitable for charging and discharging with a large current in comparison with the second battery BT2. In other words, the second battery BT2 has a smaller permissible power output per unit storage capacity than that of the first battery BT1. For instance, even when charging is conducted with a charging current several times larger than the discharging current that is generally used for supplying to the load, the first battery BT1 barely deteriorates and stays usable. The storage capacities of the first battery BT1 and second battery BT2 can be set in accordance with the power consumed in an apparatus in which the storage battery device is installed and in accordance with the expected usage environment.

The battery cells of the first battery BT1 and second battery BT2 respectively include a positive electrode, a negative electrode, and a non-aqueous electrolyte.

The negative electrode may include a current collector and a negative electrode active material-containing layer. The negative electrode active material-containing layer may be formed on one surface, or both reverse surfaces, of the current collector. The negative electrode active material-containing layer may include a negative electrode active material, and optionally an electro-conductive agent and a binder. The thickness of the negative electrode active material-containing layer (on one surface) maybe between 10 μm and 120 μm. When the negative electrode active material-containing layers are formed on both surfaces of the negative electrode current collector, the total thickness of the negative electrode active material-containing layers may be between 20 pm and 240 pm. The thickness of the positive electrode current collector is preferably from 5 μm to 20 μm.

Examples of negative electrode active materials for the battery cells of the first battery BT1 include lithium titanium-containing oxides and niobium titanium-containing oxides.

Examples of lithium titanium-containing oxides include a spinel-type lithium titanate (e.g., Li₄₊ₓTi₅O₁₂, where −1≤x≤3 or preferably 0≤x≤1), and ramsdellite-type lithium titanate such as Li_{2+y}Ti₃O₇ (where −1≤y≤3) . From the perspective of cycle performance, spinel-type lithium titanate is particularly preferable.

Examples of niobium titanium-containing oxides include monoclinic niobium-titanium composite oxide. Examples of the monoclinic niobium-titanium composite oxides include any compound represented by LiₓTi_{1-y}M1_{y}Nb_{2-z}M2_{z}O_{7+δ}, where M1 is at least one selected from the group consisting of Zr, Si, and Sn, and M2 is at least one selected from the group consisting of V, Ta, and Bi. For the respective subscripts in the composition formula, 0≤x≤5, 0≤y<1, 0≤z<2, and −0.3≤δ≤0.3 are satisfied. Specific examples of the monoclinic niobium-titanium composite oxides include LiₓNb₂TiO₇ (0≤x≤5).

As another example of the monoclinic niobium-titanium composite oxides, any compound represented by LiₓTi_{1-y}M3_{y+z}Nb_{2-z}O_{7-δ} is included, where M3 is at least one selected from the group consisting of Mg, Fe, Ni, Co, W, Ta, and Mo. For the respective subscripts in the composition formula, 0≤x<5, y<1, 0≤z<2, and −0.3≤δ≤0.3 are satisfied.

When, for example, a lithium titanium-containing oxide or niobium titanium-containing oxide is adopted as the negative electrode active material for the battery cells of the first battery BT1, a carbon material or the like may be adopted as the negative electrode active material for the battery cells of the second battery BT2.

Examples of carbon materials include carbonaceous substances that can absorb and release lithium ions. Examples of the carbonaceous substances include natural graphite, artificial graphite, coke, vapor-grown carbon fiber, mesophase pitch-based carbon fiber, spherical carbon, and resin-sintered carbon. The spacing d₀₀₂ of the crystal plane (002) of the carbonaceous substance by X-ray diffraction is preferably 0.340 nm or shorter.

As the negative electrode active material for the battery cells of the first battery BT1, a lithium titanium-containing oxide may be adopted, while as the negative electrode active material for the battery cells of the second battery BT2, a niobium titanium-containing oxide may be adopted. Furthermore the thickness of the negative electrode current collector and negative electrode active material-containing layer in the battery cells of the first battery BT1 may be smaller than that of the negative electrode current collector and negative electrode active material-containing layer in the battery cells of the second battery BT2. When this is the case, the same negative electrode active material can be used for the battery cells of the first battery BT1 and the battery cells of the second battery BT2.

The positive electrode may include a current collector and a positive electrode active material-containing layer. The positive electrode active material-containing layer may be formed on one surface, or both reverse surfaces, of the current collector. The positive electrode active material-containing layer may include a positive electrode active material, and optionally an electro-conductive agent and a binder. The thickness of the positive electrode active material-containing layer (on one surface) may be between 10 μm and 120 μm. When the positive electrode active material-containing layers are formed on both surfaces of the positive electrode current collector, the total thickness of the positive electrode active material-containing layers may be between 20 μm and 240 μm. The thickness of the positive electrode current collector is preferably from 5 μm to 20 μm.

As the positive electrode active material for the battery cells of the first battery BT1 and second battery BT2, an oxide or a sulfide may be used. The positive electrode may include, as the positive electrode active material, one kind of compound alone or two or more kinds of compounds in combination Examples of the oxide and sulfide include compounds into which Li or Li ions can be inserted and from which they can be extracted. Examples of such compounds include manganese dioxide (MnO₂), iron oxide, copper oxide, nickel oxide, lithium manganese composite oxides (e.g. , LiₓMn₂O₄ or LiₓMn₂, where 0<x≤1) , lithium nickel composite oxides (e.g. , LiₓNiO₂, where 0<x≤−1) , lithium cobalt composite oxides (e.g. , LiₓCoO₂, where 0<x≤1), lithium nickel cobalt composite oxides (e.g., LiₓNi_{1-y}Co_{y}O₂, where 0<x1, 0<y<1), lithium manganese cobalt composite oxides (e.g. , LiₓMn_{y}Co_{1-y}O₂, where 0<x≤1, 0<y<1) , lithium manganese nickel composite oxides having a spinel structure (e.g., LiₓMn_{2-y}Ni_{y}O₄, where 0<x≤1, 0<y<2), lithium phosphorus oxide having an olivine structure (e.g., LiₓFePO₄, where 0<x≤1; LiₓFe_{1-y}Mn_{y}PO₄, where 0<x≤1, 0<y≤1; or LiₓCoPO₄, where 0<x≤1), ferrous sulfate (Fe₂(SO₄)₃), vanadium oxide (e.g., V₂O₅), and lithium nickel cobalt manganese composite oxides (LiₓNi_{1-y-z}Co_{y}Mn_{z}O₂, where 0<x≤1, 0<y<1, 0<z<1, y+z<1).

Among the above compounds, examples of more preferred compounds as a positive electrode active material include lithium manganese composite oxides having a spinel structure (e.g., LiₓMn₂O₄, where 0<x≤1), lithium nickel composite oxides (e.g., LiₓNiO₂, where 0<x≤1), lithium cobalt composite oxides (e.g., LiₓCoO₂, where 0<x≤1), lithium nickel cobalt composite oxides (e.g., LiₓMn_{2-y}Ni_{y}O₄, where 0<x≤1, 0<y<1), lithium manganese nickel composite oxides having a spinel structure (e.g., LiₓMn_{2-y}Ni_{y}O₄, where 0<x≤1, 0<y<2), lithium manganese cobalt composite oxides (e.g., LiₓMn_{y}Co_{1-y}O₂, where 0<x≤1, 0<y<1) , lithium iron phosphates (e.g., LiₓFePO₄, where 0<x≤1) and lithium nickel cobalt manganese composite oxides (LiₓNi_{1-y-z}Co_{y}Mn_{z}O₂, where 0<x≤1, 0<y<1, 0<z<1, y+z<1). The use of any of these compounds as a positive electrode active material increases the potential of the positive electrode.

Furthermore, the thickness of the positive electrode current collector and positive electrode active material-containing layer in the battery cells of the first battery BT1 maybe smaller than that of the positive electrode current collector and positive electrode active material-containing layer in the battery cells of the second battery BT2.

The DC/DC converter 30 is interposed between the positive terminal of the first battery BT1 and the positive terminal of the second battery BT2 so as to convert the output power of either the first battery BT1 or second battery BT2 to a specific level of power and output the resultant power to the other battery.

The DC/DC converter 30 includes switching elements SA and SB, a PWM circuit 31, a coil L, and a capacitor C.

The switching element SA and switching element SB are connected in series between the positive terminal and negative terminal of the second battery BT2 (between the high-voltage side and low-voltage side of the second main circuit) , and part of the path between the switching element SA and switching element SB is electrically connected to the positive terminal of the first battery BT1 by way of the coil L. The capacitor C is connected between the positive terminal and negative terminal of the first battery BT1 (between the high-voltage side and low-voltage side of the first main circuit) .

Each of the first main circuit and the second main circuit is includes the high-voltage side circuit and low-voltage side circuit.

The PWM circuit 31 generates gate signals for controlling the gate potentials of the switching element SA and switching element SB, based on a control signal (DC/DC converter current command value) supplied from the battery management circuit 20. The PWM circuit 31 uses the control signal (including the current command value and output current value) supplied from the battery management circuit 20 to generate a modulated wave based on a difference between the output current value and current command value, and compares the modulated wave with a preset carrier wave to generate the gate signals of the switching element SA and switching element SB.

The current sensor CS detects a value of the output current of the storage battery device and supplies the value to the battery management circuit 20.

The battery management circuit 20 may include, for example, at least one processor and a memory that stores programs therein to be implemented by the processor, and may be configured to implement various functions by software (or by software and hardware in combination).

The battery management circuit 20 is communicably connected to the host control device (e.g., vehicle control unit (vehicle ECU)) of the load apparatus by way of an accessory device power terminal, an activation signal terminal, and a two-way communication terminal. The battery management circuit 20 receives power from the accessory device power source (external source) through the accessory device power terminal. The battery management circuit 20 is a control circuit that is activated by an activation signal, which is supplied from the host control device through the activation signal terminal, and controls the operation of the storage battery device based on the control signal supplied from the host control device through the two-way communication terminal. The battery management circuit 20 acquires an output command value for the load (e.g., current value (or current command value) of the inverter that drives the motor) from the host control device through the two-way communication terminal.

The battery management circuit 20 receives temperature and voltage information from each of the first battery monitoring circuit 11 and second battery monitoring circuit 12, and acquires the output current value of the storage battery device from the current sensor CS.

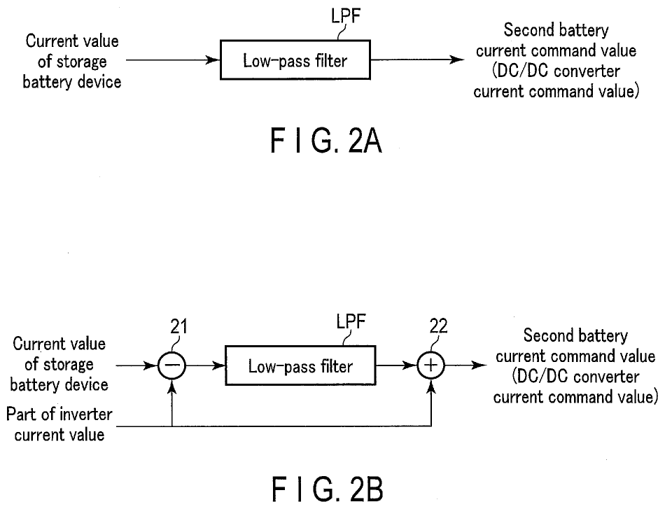

FIG. 2A is a schematic diagram showing an exemplary configuration included in a battery management circuit of the storage battery device illustrated in FIG. 1. The battery management circuit 20 includes a low-pass filter LPF. The low-pass filter LPF performs low-pass filtering upon the input current value of the storage battery device, and outputs the current command value of the second battery BT2 (current command value of the DC/DC converter 30) . For instance, when the storage battery device is installed in an electric vehicle, the discharging current of the first battery BT1 serves as the output current of the storage battery device at the timing of the driver starting using the acceleration or brake.

FIG. 2B is a schematic diagram showing another exemplary configuration included in a battery management circuit of the storage battery device illustrated in FIG. 1.

In the electric vehicle with the storage battery device, in order to enhance the performance of the vehicle when power is received from the storage battery device at the acceleration and deceleration of the electric vehicle, part of the current value to the inverter for driving the motor maybe added to the current command value of the second battery BT2. In this manner, the second battery BT2 can also serve as part of the output current of the storage battery device even at the very moment of the driver starting using the acceleration or brake.

In this example, the battery management circuit 20 includes a subtractor 21, a low-pass filter LPF, and an adder 22. A value (output value of the subtractor 21) obtained by subtracting part of the current value of the inverter from the current value of the storage battery device is input to the low-pass filter LPF. The low-pass filter LPF performs low-pass filtering upon the input value, and outputs the resultant value to the adder 22. The adder 22 adds the output value of the low-pass filter LPF and part of the current value of the inverter, and outputs the added value as the current command value of the second battery BT2 (current command value of the DC/DC converter 30).

Here, part of the current value (command value) of the inverter is added as-is to the output value of the adder 22. However, the current value (command value) of the inverter may be subjected to high-pass filtering, and the resultant value may be added to the output value of the adder 22 to compensate the delay in rising of the current of the second battery BT2.

The battery management circuit 20 is configured to calculate the state of charge (SOC) of the battery cells and state of health (SOH) of the battery cells based on the received information regarding the voltage, temperature and output current of the battery cells. The battery management circuit 20 transmits the calculated SOC and SOH values to the vehicle through the two-way communication terminal. The battery management circuit 20 also controls the first battery monitoring circuit 11 and second battery monitoring circuit 12 based on the calculated SOC values in such a manner that the voltages of the battery cells can be equalized.

For instance, the battery management circuit 20 determines, based on the calculated SOC values, whether the first battery BT1 and second battery BT2 are reaching an over-discharging state. When either one of the first battery BT1 and second battery BT2 is reaching the over-discharging state, the battery management circuit 20 charges this battery from the other battery via the DC/DC converter 30 so as to avoid any damage to the battery due to the over-discharging state. The first battery BT1 and second battery BT2 may also differ in the capacity reduction due to self-discharging. When the storage battery device is left unused for a long period of time, one of the batteries maybe damaged, obstructing the activation of the storage battery device. The storage battery device of the present application, however, can prevent the first battery BT1 and second battery BT2 from falling into the over-discharging state.

Furthermore, the battery management circuit 20 controls the operations of the breakers CN1 and CN2, based on the command from the host control device, or based on the information acquired from the battery monitoring circuits 11 and 12 or the host control device. For instance, when it is determined based on the voltages and temperatures of the first battery BT1 and second battery BT2 that either one of the first battery BT1 and second battery BT2 is abnormal, the battery management circuit 20 may notify the host control device of the abnormality, and may also open the corresponding one of the breaker CN1 and CN2. When either one of the first battery BT1 and second battery BT2 fails, power supply to the load can be continued from the other battery alone.

When the storage battery device is being charged, the battery management circuit 20 determines based on the SOC of the first battery BT1 and second battery BT2 whether the battery has reached the fully charged state, and informs the vehicle that the charging should be terminated when the fully charged state has been reached. For instance, when the storage battery device is installed in an electric vehicle, it is preferable that the charge amount be controlled such that the first battery BT1 can be charged with the regenerative current of the electric vehicle. For instance, the battery management circuit 20 may determine the state in which the second battery BT2 exhibits a charge rate higher than that of the first battery BT1, to be the fully charged state. When A% denotes the SOC of the first battery BT1 indicating the charge amount with the regenerative current, the battery management circuit 20 determines that the fully charged state has been achieved when the SOC of the first battery BT1 is 100-A [%] , and the SOC of the second battery BT2 is 100%.

The battery management circuit 20 receives the output current and temperature of the DC/DC converter 30 from the DC/DC converter 30. The battery management circuit 20 also obtains from the current sensor CS, the output current value output from the DC/DC converter 30 to the first main circuit, and outputs to the DC/DC converter 30 a control signal that will bring the output current value close to the current command value supplied from the host control device to the DC/DC converter 30.

In the above storage battery device, the second battery BT2 having a large storage capacity and being unsuitable for large-current charging and discharging, and the first battery BT1 having a storage capacity smaller than that of the second battery BT2 and being suitable for large-current charging and discharging, are connected in parallel, and the DC/DC converter 30 capable of performing two-way power conversion is connected between the first battery BT1 and second battery BT2. The charging/discharging terminals T1 and T2 are connected to the positive terminal and negative terminal, respectively, of the first battery BT1.

Such a configuration realizes a large-capacity storage battery device capable of large-current charging and discharging. For instance, when the storage battery device according to the present embodiment is installed in an electric vehicle, the average effective value of the output current during the driving of the electric vehicle can be reduced, which can suppress an increase in the temperature of the second battery BT2. The amount of heat generated in the battery can be calculated by multiplying the square of the value of the charging/discharging current by a resistance value (e.g., internal battery resistance and interconnection resistance). With an increase in the charging/discharging current, the amount of heat also increases. The charging/discharging current of the storage battery device in the moving electric vehicle increases, for example, at the timing of acceleration and deceleration. At the timing of the increase in the charging/discharging current, the storage battery device according to the present embodiment performs charging and discharging from the first battery BT1. When the electric vehicle is moving for a short distance, the vehicle can reach the destination with discharging from the first battery BT1 alone, which can prevent the temperature of the second battery BT2 from increasing. Thus, even after driving of the electric vehicle, the storage battery device can be quickly recharged.

In comparison with the second battery BT2, the first battery BTl that is suitable for charging and discharging with a large current is relatively costly. With the first battery BT1 having a smaller storage capacity than that of the second battery BT2, however, a storage battery device of a desired capacity can be realized at low cost.

Furthermore, by controlling the output power of the DC/DC converter 30 to be smaller than the output power of the storage battery device, the current flowing into the DC/DC converter 30 can be suppressed. This can downsize the coil L in the DC/DC converter 30, which can realize the DC/DC converter 30 at low cost.

Next, an exemplary usage of the storage battery device in the electric vehicle having the storage battery device according to the present embodiment will be explained.

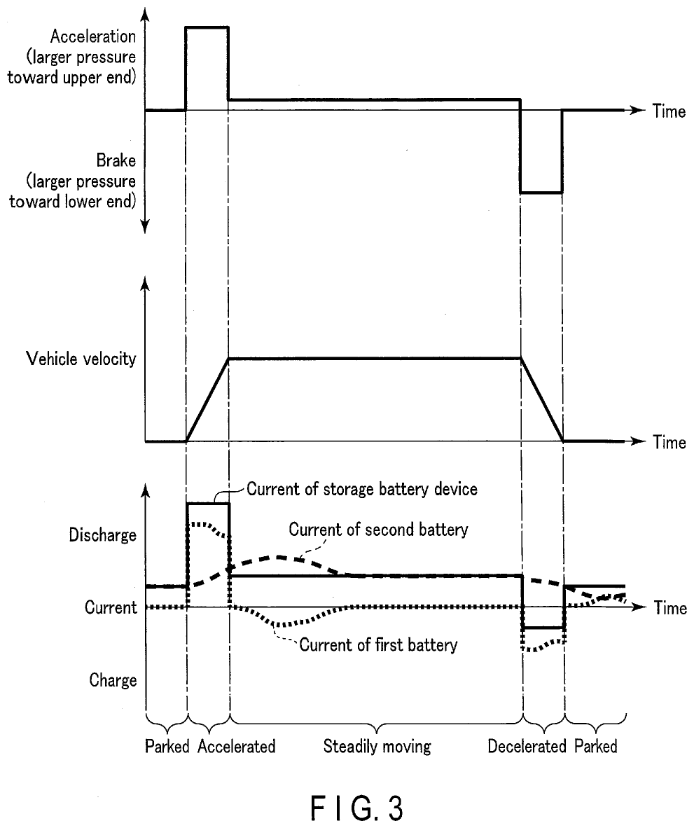

FIG. 3 is a schematic diagram showing an exemplary usage state of the storage battery device according to an embodiment in an electric vehicle having the storage battery device installed therein.

This drawing schematically illustrates temporal changes in the velocity of the vehicle and the charging/discharging current of the storage battery device in a time period when the parked electric vehicle starts moving with the accelerator being pressed down and thereafter makes a stop with the brake being pressed down. Here, the undulations of the road on which the electric vehicle is driving is not taken into consideration, and it is assumed that the vehicle is driving on a flat road.

During a stop of the electric vehicle, a zero pressing pressure is applied to an acceleration pedal or brake pedal. When the electric vehicle is at a stop but the air conditioner or accessory devices are being used, discharging is being performed from the storage battery device. The discharging current at this time is relatively small in comparison with the acceleration of the electric vehicle, and therefore the storage battery device does not need to perform discharging with a large current. Thus, during this period, a discharging current is output mainly from the second battery BT2 that does not suit large-current charging and discharging. When a larger pressing pressure is applied to the acceleration pedal, the discharging current from the storage battery device increases to keep the vehicle moving. The acceleration of the vehicle requires discharging with a large current. Thus, the power required for acceleration is discharged from the first battery BT1. On the other hand, the second battery BT2 performs low-pass filtering upon the discharging current value of the storage battery device and discharges a current having a time-averaged value. Part of the power required for the acceleration may be discharged from the second battery BT2, depending on the acceleration rate of the vehicle velocity and the discharging capacity of the first battery BT1.

After the vehicle reaches a certain speed, the pressing pressure upon the acceleration pedal decreases, and the electric vehicle moves steadily at a constant speed, without acceleration. During the period when the electric vehicle is moving steadily, the power that compensates the motion energy associating with the moving of the storage battery device and the power to be supplied to the accessory devices is discharged The power consumed here is relatively small in comparison with the acceleration of the electric vehicle, and therefore the storage battery device does not need to perform large-current discharging. For this reason, during this period, a discharging current is output mainly from the second battery BT2 that does not suit large-current charging and discharging.

As a result of the discharging at the time of acceleration of the electric vehicle, the charge amount of the first battery BT1 has been reduced. Thus, a charging current is supplied from the second battery BT2 to the first battery BT1 during the period when the electric vehicle moves steadily. As a result, when the electric vehicle is accelerated again, the energy stored in the first battery BT1 can be used.

During steady movement, when the pressing pressure upon the brake pedal increases, the electric vehicle is decelerated During the deceleration of the electric vehicle, a regenerative current is supplied to the storage battery device Here, the first battery BT1 is charged with the regenerative current. The second battery BT2 discharges a current having a time-averaged value obtained through low-pass filtering of the charging current value of the storage battery device. The second battery BT2 may be charged with part of the regenerative current supplied to the storage battery device. In general, when the electric vehicle is at a stop, part of the energy is absorbed by the machine brake, and therefore the energy regenerated to the storage battery device is smaller than the energy required by the electric vehicle at the time of acceleration. Thus, it is possible to charge the storage battery device with all the energy regenerated during deceleration.

As a simple mechanism of suppressing the peak of the charging/discharging current for the second battery BT2, the method with which the second battery BT2 takes responsibility for the low-pass components of the current of the storage battery device has been described here. However, the algorithm is not limited to this example as long as the peak of the charging/discharging current for the second battery BT2 can be suppressed.

The heat generation in a battery is proportional to the square of the current, and therefore the heat generation of the battery can be effectively suppressed by suppressing the peak current. This can simplify the cooling system of the second battery BT2, and can also suppress the deterioration of the second battery BT2. In addition, an increase in the temperature of the storage battery device after the driving of the electric vehicle can be suppressed. Thus, the storage battery device can be rapidly recharged immediately after the driving, and therefore driving and charging can be continuously performed. That is, with the storage battery device according to the present embodiment installed in an electric vehicle, a simple and reliable electric vehicle can be realized.

As described above, according to the present embodiment, a storage battery device that can suppress deterioration of batteries and can perform charging and discharging with a large current, as well as an electric vehicle including such a storage battery device, can be offered.

Next, a storage battery device according to the second embodiment will be described in detail with reference to the drawings.

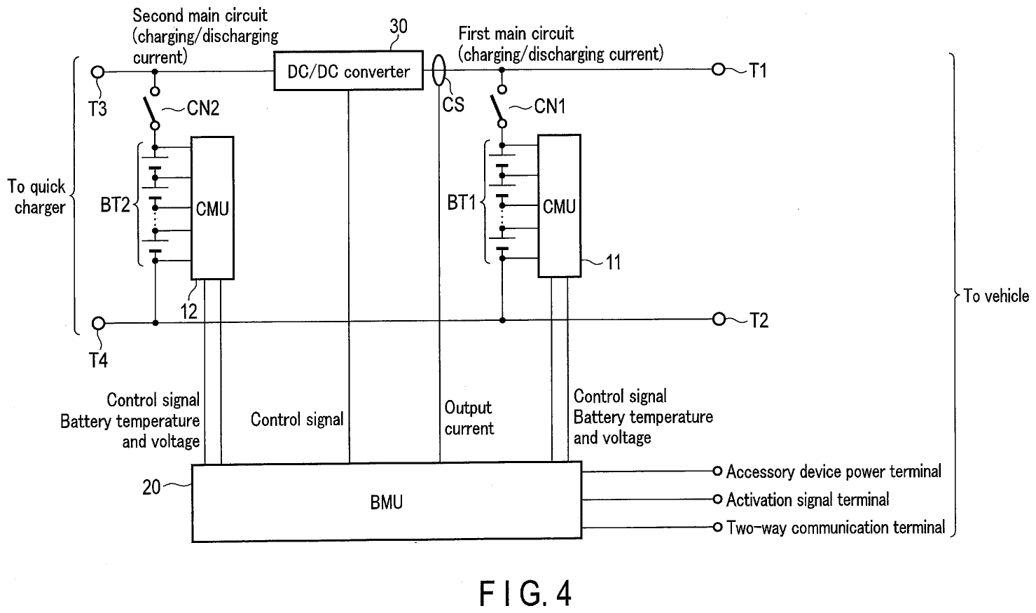

FIG. 4 is a schematic diagram showing an exemplary configuration of the storage battery device according to the second embodiment.

In the following description, the same reference numerals will be given to the same structural components as in the storage battery device of the first embodiment, and the explanation thereof will be omitted.

The storage battery device according to the present embodiment further includes a third terminal T3 and a fourth terminal T4.

The third terminal T3 is electrically connected to the positive terminal of the second battery BT2 (high-voltage side of the second main circuit).

The fourth terminal T4 is electrically connected to the negative terminal of the second battery BT2 (low-voltage side of the second main circuit). The third terminal T3 and fourth terminal T4 are used as charging terminals to which a charger such as a quick charger can be connected. When charging the storage battery device according to the present embodiment, a charger is connected to the third terminal T3 and fourth terminal T4 so that a charging current can be suppled from the second main circuit to the second battery BT2, and a charging current can be supplied to the first battery BTl via the DC/DC converter 30 and first main circuit.

The first terminal T1 and second terminal T2 are generally used as charging/discharging terminals connected to a load apparatus (e.g., electric vehicle) . For instance, the power regenerated by a load apparatus such as an electric vehicle is sporadic, and therefore can be controlled to be used for charging the first battery BT1 only. As a result, during the driving of the electric vehicle, the second battery BT2 performs only discharging, without being charged. Furthermore, in the storage battery device according to the present embodiment, the DC/DC converter 30 does not need to perform conversion and output of power from the first main circuit to the second main circuit.

As described above, the DC/DC converter 30 can realize one-way output, eliminating the need for switching elements SB as illustrated in FIG. 1, for example. Thus, according to the present embodiment, the same effects can be attained as in the aforementioned storage battery device according to the first embodiment, and in addition, a downsized storage battery device can be offered at reduced cost, with the DC/DC converter 30 having fewer components.

That is, according the present embodiment, a storage battery device that can suppress deterioration of batteries and can perform charging and discharging with a large current, as well as an electric vehicle including such a storage battery device, can be offered.

Next, the storage battery device according to the third embodiment will be explained in detail with reference to the drawings.

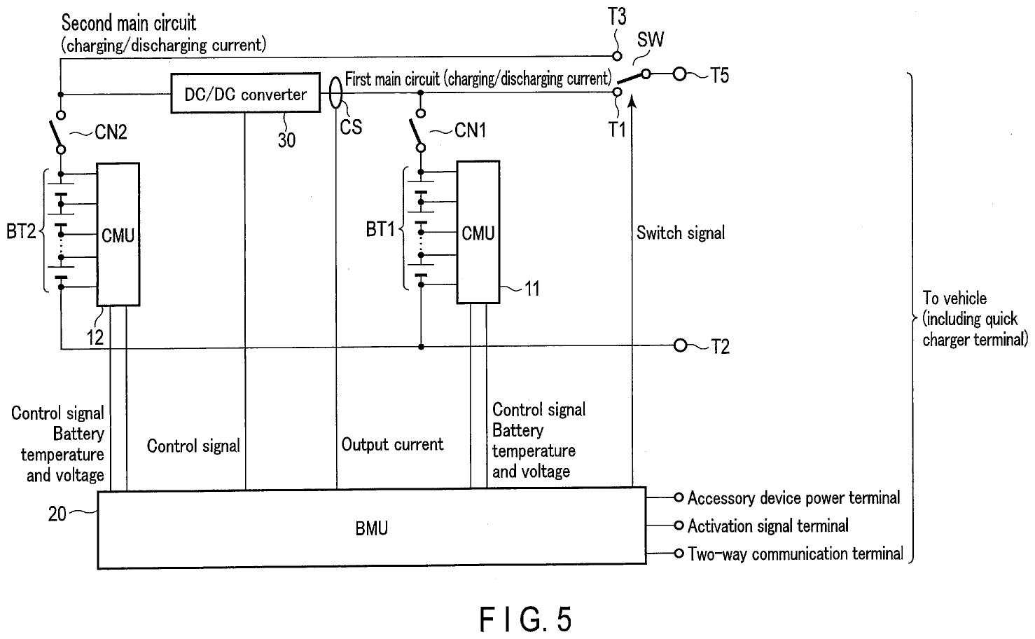

FIG. 5 is a schematic diagram showing an exemplary configuration of the storage battery device according to the third embodiment.

The storage battery device according to the present embodiment differs in part of the configuration from the storage battery device according to the second embodiment.

That is, the storage battery device according to the present embodiment includes a fifth terminal T5 and a switch SW.

The switch SW is configured to perform switching for a main circuit to be electrically connected to the fifth terminal T5 so that an electrical connection can be established between the fifth terminal T5 and either one of the first terminal T1 and third terminal T3.

The fifth terminal T5 and second terminal T2 are charging/discharging terminals that can be connected to the main circuit of the load apparatus (e.g., electric vehicle) in which the storage battery device is installed, and to the charging terminals electrically connected to this main circuit. When the fifth terminal T5 is electrically connected to the first terminal T1, the fifth terminal T5 and second terminal T2 are used as charging and discharging terminals. When the fifth terminal T5 is electrically connected to the third terminal T3, the fifth terminal T5 and second terminal T2 are used as charging terminals.

In the storage battery device according to the present embodiment, the second terminal T2 can serve as the fourth terminal T4 of the aforementioned storage battery device according to the second embodiment, and therefore the fourth terminal T4 can be eliminated.

Upon notification from the host control device that a charger is connected, for example, the battery management circuit 20 controls the switch SW so as to bring the third terminal T3 and fifth terminal T5 into an electrical connection. Furthermore, upon notification from the host control device that the charger is disconnected, for example, the battery management circuit 20 controls the switch SW so as to bring the first terminal T1 and fifth terminal T5 into an electrical connection.

According to the present embodiment, the same effects as in the storage battery device of the second embodiment can be achieved. For instance, during the driving of the electric vehicle, the second battery BT2 performs only discharging, without being charged. Furthermore, in the storage battery device according to the present embodiment, the DC/DC converter 30 does not need to perform conversion and output of the power from the first main circuit to the second main circuit.

Thus, according to the present embodiment, the same effects can be attained as in the aforementioned storage battery device according to the first embodiment, and in addition, a downsized storage battery device can be offered at reduced cost, with the DC/DC converter 30 having fewer components.

Furthermore, according to the present embodiment, the fourth terminal T4 in the storage battery device of the second embodiment can be omitted. This can prevent the configuration of the storage battery device from becoming complicated, and can offer a storage battery device at still lower cost.

That is, according to the present embodiment, a storage battery device that can suppress deterioration of batteries and can perform charging and discharging with a large current, as well as an electric vehicle including such a storage battery device, can be offered.

Next, a storage battery device and an electric vehicle according to the fourth embodiment will be described in detail with reference to the drawings.

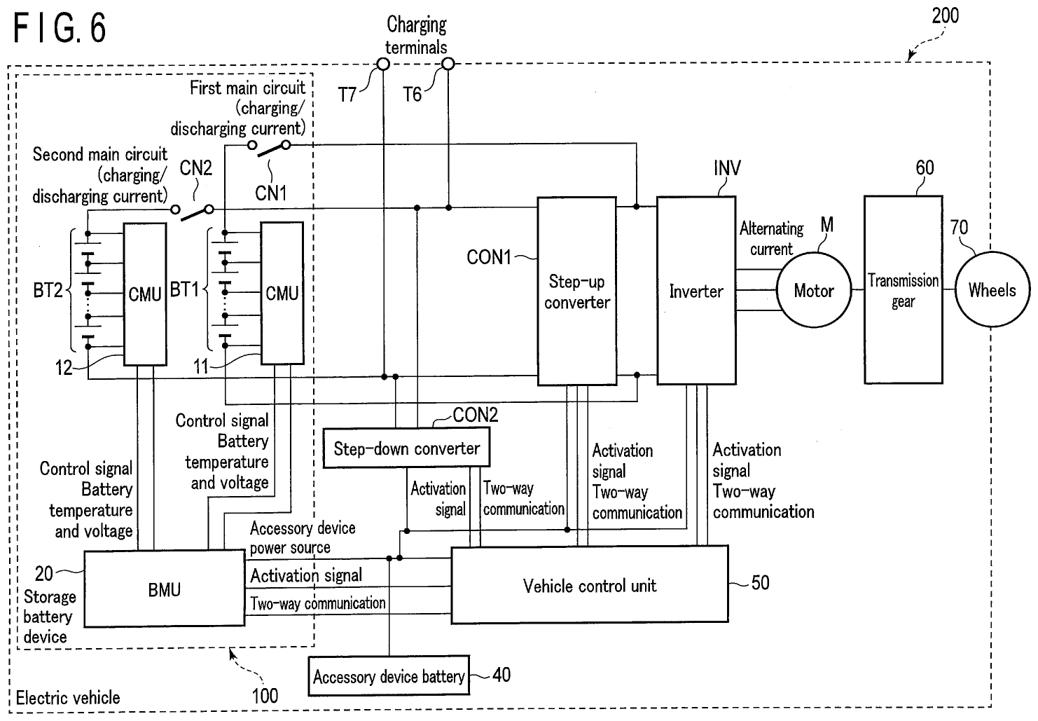

FIG. 6 is a schematic diagram showing an exemplary configuration of the storage battery device and electric vehicle according to the fourth embodiment.

In the present embodiment, an exemplary configuration of an electric vehicle having a booster circuit, where the storage battery device according to the aforementioned embodiments is installed in the electric vehicle, will be described.

An electric vehicle 200 according to the present embodiment includes a storage battery device 100, an accessory device battery 40, a vehicle control unit (vehicle ECU) 50, a transmission gear 60, wheels 70, a motor M, a step-up converter CON1, a step-down converter CON2, an inverter INV, and charging terminals T6 and T7.

The accessory device battery 40 may be a lead battery, which can supply power to the battery management circuit 20, the step-up converter CON1, the step-down converter CON2, the inverter INV, and the vehicle control unit 50 of the storage battery device 100.

The step-down converter CON2 has a high-voltage side terminal, which is electrically connected to the low-voltage side of the main circuit (second main circuit), and a low-voltage side terminal, which is electrically connected to the accessory device power supply line. The step-down converter CON2 is configured to lower the voltage of the direct-current power supplied from the second main circuit to a certain voltage level and supply the resultant power to the accessory device power supply line so as to charge the accessory device battery 40.

The low-voltage side of the step-up converter CON1 is electrically connected to the storage battery device 100 via the second main circuit, and is also electrically connected to the charging terminals T6 and T7. The high-voltage side of the step-up converter CON1 is electrically connected to the storage battery device 100 via the first main circuit, and is also electrically connected to the direct-current terminal of the inverter INV.

The step-up converter CON1 is configured to raise the voltage of the direct-current power supplied from the storage battery device 100 via the second main circuit to a certain voltage level and supply the resultant power to the direct-current terminal of the inverter INV. By raising the voltage of the direct-current power to be supplied to the inverter INV, the current flowing into the inverter INV can be reduced, which can reduce a loss in the inverter INV.

The step-up converter CON1 is further configured to raise the voltage of the charging power supplied from the charging terminals T6 and T7 via the second main circuit to a certain voltage level, and supply the resultant power to the storage battery device 100 via the first main circuit.

The direct-current terminal of the inverter INV is electrically connected to the high-voltage side terminal of the step-up converter CON1 and to the first main circuit. The alternating-current terminals of the inverter INV are electrically connected to the motor M.

The inverter INV is a two-way direct-current three-phase alternating-current inverter, which can convert the direct-current power supplied from the direct-current terminal to alternating-current power and output it to the alternating-current terminal, and also can convert the alternating-current power supplied from the alternating-current terminal to direct-current power and output it to the direct-current terminal.

The motor M is rotary-driven with the alternating current supplied from the inverter INV, and also operates as a generator, converting the motion energy generated by the rotation of the wheels 70 to electric power and supplying the regenerative power to the inverter INV.

The transmission gear 60 conveys the torque generated by the rotation of the motor M to the wheels 70 by increasing or decreasing the torque in accordance with the driving conditions of the electric vehicle.

The vehicle control unit 50 is a control circuit for controlling the components of the electric vehicle in such a manner that the components can operate in coordination. The vehicle control unit 50 may include at least one processor and a memory that stores programs that are to be implemented by the processor, realizing various functions by software (or software and hardware in combination). The vehicle control unit 50 is configured to be bidirectionally communicable with the step-up converter CON1, step-down converter CON2, and inverter INV, as well as the battery management circuit 20 of the storage battery device 100, and sends activation signals to these components.

The vehicle control unit 50 determines the state of the electric vehicle 200 based on the information acquired from different components and sensors included in the electric vehicle 200, and thereby controls the operations of the step-up converter CON1, step-down converter CON2, inverter INV, and the battery management circuit 20 of the storage battery device 100.

The vehicle control unit 50 may have a configuration similar to that of FIG. 2A or 2B.

For instance, in the same manner as in FIG. 2A, the vehicle control unit 50 may include a low-pass filter LPF. An inverter current value is input to the low-pass filter LPF. The low-pass filter LPF performs low-pass filtering upon the input inverter current value, and outputs the current command value of the step-up converter CON1. At the timing of the driver starting using the acceleration or brake, the discharging current of the first battery BT1 serves as the output current of the storage battery device.

In another example, in order to enhance the performance of the vehicle when power is received from the storage battery device at the acceleration and deceleration of the electric vehicle, part of the current value to the inverter INV for driving the motor M may be added to the current command value of the step-up converter CON1. In this manner, the second battery BT2 can serve as part of the output current of the storage battery device even at the very moment of starting using the acceleration or brake.

In the above example, the vehicle control unit 50 may include a subtractor 21, a low-pass filter LPF, and an adder 22, in the same manner as in FIG. 2B. A value obtained by subtracting part of the inverter current value from the inverter current value (i.e., the output value of the subtractor 21) is input to the low-pass filter LPF. The low-pass filter LPF performs low-pass filtering upon the input value, and the resultant value is output to the adder 22. The adder 22 adds the output value of the low-pass filter LPF and part of the inverter current value, and outputs it as the current command value of the step-up converter CON1.

Here, part of the current value (command value) of the inverter is added as-is to the output value of the adder 22. However, the part of the inverter current value may be subjected to high-pass filtering, and the resultant value may be added to the output value of the adder 22 so as to compensate the delay in rising of the current of the second battery BT2.

The storage battery device 100 according to the present embodiment includes a first battery module, a second battery module, a battery management circuit 20, and breakers CN1 and CN2. The first battery module includes a first battery BT1 and a first battery monitoring circuit 11. The second battery module includes a second battery BT2 and a second battery monitoring circuit 12.

The storage battery device 100 according to the present embodiment differs from the storage battery device of the first embodiment in the aspects of not including a DC/DC converter 30, and the first battery BT1 and second battery BT2 being respectively connected to the step-up converter CON1 of the electric vehicle 200 via the corresponding main circuits.

That is, the positive terminal and negative terminal of the first battery BT1 are electrically connected to the high-voltage side terminal of the step-up converter CON1 and the direct-current terminal of the inverter INV via the first main circuit. The positive terminal and negative terminal of the second battery BT2 are electrically connected to the low-voltage side terminal of the step-up converter CON1 and the charging terminals T6 and T7 via the second main circuit.

In the electric vehicle according to the present embodiment, when charging begins with a charger connected to the charging terminals T6 and T7, the charging current is supplied to the second battery BT2 via the second main circuit, and to the first battery BT1 via the second main circuit, step-up converter CON1, and first main circuit.

That is, the electric vehicle according to the present embodiment can achieve the same effects as in the above first and second embodiments, and a storage battery device capable of suppressing deterioration of the batteries and of charging and discharging with a large current, as well as an electric vehicle including such a storage battery device, can be offered.

In addition, in the electric vehicle according to the present embodiment, the first battery BT1 is connected directly to the direct-current terminal of the inverter INV (without a step-up converter CON1 intervening) by way of the first main circuit, and therefore fluctuations in the current flowing into the direct-current terminal of the inverter INV can be charged to the first battery BT1 or discharged from the first battery BT1. Thus, in the electric vehicle according to the present embodiment, the fluctuated current does not need to be taken into consideration when determining the current rating of the step-up converter CONI . With the current rating of the step-up converter CON1 that can be set low, a step-up converter CON1 can be prepared at lower cost. This allows for production of an electric vehicle at lower cost.

In addition, in the same manner as in the DC/DC converter of the above second and third embodiments, the step-up converter CON1 in the electric vehicle according to the present embodiment can realize one-way output. Thus, the step-up converter CON1 can be downsized with fewer components, and an electric vehicle can be offered at lower cost. While certain embodiments have been described, these embodiments have been presented by way of example only, and are not intended to limit the scope of the inventions.

Indeed, the novel methods and systems described herein may be embodied in a variety of other forms; furthermore, various omissions, substitutions and changes in the form of the methods and systems described herein may be made without departing from the spirit of the inventions.

The accompanying claims and their equivalents are intended to cover such forms or modifications as would fall within the scope and spirit of the inventions.

1. A storage battery device comprising:
a first battery configured to output alternating-current power for driving a motor of a vehicle and connected to a first main circuit that is electrically connected to a direct-current terminal of an inverter to which regenerative power is supplied from the motor;
a second battery connected to a second main circuit, having a storage capacity larger than a storage capacity of the first battery, and having a permissible power output per unit storage capacity smaller than a permissible power output of the first battery;
a DC/DC converter configured to convert a voltage of power supplied from the second main circuit to a predetermined voltage and output the power to the first main circuit;
a control circuit configured to control charging and discharging operations of the first battery and the second battery and control an operation of the DC/DC converter;
a first terminal electrically connected to a positive terminal of the first battery via a high-potential side of the first main circuit; and
a second terminal electrically connected to a negative terminal of the first battery via a low-potential side of the first main circuit.

2. The storage battery device according to claim 1, wherein
the control circuit controls the DC/DC converter in such a manner that an output of the DC/DC converter is smaller than an output that is supplied to outside via the first terminal and the second terminal.

3. The storage battery device according to claim 1, wherein
the DC/DC converter is configured to convert a voltage of power supplied from the first main circuit to a predetermined voltage and output the power to the second main circuit, and
the control circuit performs control such that the second battery is charged with charging power supplied through the first terminal and the second terminal via the DC/DC converter.

4. The storage battery device according to claim 1, wherein
the control circuit determines that the storage battery device is in a fully charged state when a charge rate of the second battery is higher than a charge rate of the first battery.

5. The storage battery device according to claim 1, further comprising:
a third terminal electrically connected to a positive terminal of the second battery via a high-potential side of the second main circuit; and
a fourth terminal electrically connected to a negative terminal of the second battery via a low-potential side of the second main circuit,
wherein the control circuit performs control such that the first battery is charged with charging power supplied through the third terminal and the fourth terminal via the DC/DC converter.

6. The storage battery device according to claim 1, further comprising:
a third terminal electrically connected to a positive terminal of the second battery via a high-potential side of the second main circuit;
a fifth terminal connected to a load apparatus; and
a switch configured to switch, in response to a control signal of the control circuit, between the third terminal and the first terminal to be electrically connected to the fifth terminal,
wherein the control circuit controls the switch such that the fifth terminal and the third terminal are electrically connected to each other when a charger is connected to the load apparatus such that the first battery is charged with charging power supplied through the third terminal and the second terminal via the DC/DC converter.

7. The storage battery device according to claim 1, wherein
the control circuit performs control such that, when either one of the first battery and the second battery is reaching an over-discharging state, one of the first battery and the second battery is charged from the other one of the first battery and the second battery via the DC/DC converter.

8. The storage battery device according to claim 1, wherein
the positive terminal of the first battery is electrically connected to the first main circuit via a first breaker,
a positive terminal of the second battery is electrically connected to the second main circuit via a second breaker, and
when it is determined that the first battery is abnormal, the control circuit breaks an electric connection between the first main circuit and the first battery by releasing the first breaker, and when it is determined that the second battery is abnormal, the control circuit breaks an electric connection between the second main circuit and the second battery by releasing the second breaker.

9. The storage battery device according to claim 1, wherein in a fully charged state, the second battery has a voltage higher than a voltage of the first battery.

10. An electric vehicle comprising:
a motor;
an inverter configured to output alternating-current power for driving the motor, and receive regenerative power from the motor;
a first battery electrically connected to a direct-current terminal of the inverter via a first main circuit;
a second battery connected to a second main circuit, having a storage capacity larger than a storage capacity of the first battery, and having a permissible power output per unit storage capacity smaller than a permissible power output of the first battery;
a step-up converter configured to raise a voltage of direct-current power supplied from the second main circuit to a predetermined voltage and output the direct-current power to the first main circuit and the direct-current terminal of the inverter; and
a charging terminal electrically connected to the second main circuit.
